(19) United States
(12) Patent Application Publication
(10) Pub. No.: US 2026/0250799 A1
(43) Pub. Date: Aug. 27, 2026

(54) METHOD FOR RECOVERING COPPER OR COPPER ALLOY FROM ENAMELED WIRE

(71) Applicant: Proterial, Ltd., Tokyo (JP)

(72) Inventors: Tetsuro SATO, Tokyo (JP); Kenichi OKAMOTO, Tokyo (JP); Ko KERUMA, Tokyo (JP); Masamichi KISHI, Tokyo (JP); Kazuhisa TAKAHASHI, Tokyo (JP); Yuri MURAKAMI, Tokyo (JP)

(21) Appl. No.: 19/529,980

(22) Filed: Feb. 4, 2026

(30) Foreign Application Priority Data
Feb. 21, 2025 (JP) 2025-027321

(51) Int. Cl. C22B 1/24; C22B 7/00; C22B 15/00

(52) U.S. Cl. CPC C22B 1/24; C22B 7/005; C22B 15/00

(57) ABSTRACT

The present invention provides a method for recovering copper or copper alloy from enameled wire, which has a low environmental load and low processing cost, and which is capable of efficiently recovering copper in a batch manner even when enameled wires having various shapes and lengths are mixed together. In a recovery method for recovering copper or copper alloy by removing an insulator 22 from an enameled wire 2, the method includes a crushing step of charging a plurality of enameled wires 2 having different lengths and shapes into a crusher 3 and crushing the enameled wires 2 to shorten the enameled wires 2, a separating step of subjecting the enameled wires 2 shortened in the crushing step to compression processing or rolling processing to separate the insulator 22 from the conductor 21, and a stripping step of stripping the insulator 22 separated from the conductor 21 in the separating step.

### CROSS-REFERENCE TO RELATED APPLICATIONS

The present application is based on Japanese patent application No. 2025-027321 filed on Feb. 21, 2025, the entire contents of which are incorporated herein by reference.

### TECHNICAL FIELD

The present invention relates to a method for recovering copper or copper alloy from enameled wire.

An enameled wire in which an insulator is formed by coating and drying enamel varnish around a conductor has been known. For the enameled wire, it is known that removal of the insulator from the conductor and recovery of copper are difficult in disposing of the enameled wire because of high adhesion between the conductor and the insulator.

### BACKGROUND OF THE INVENTION

Patent Literature 1 discloses a method for removing an insulator from an enameled wire by heating and carbonizing the insulator of the enameled wire, and then applying mechanical force to the insulator. Patent Literature 2 discloses a method for removing an insulator from an enameled wire by immersing the enameled wire in an alkaline solution to hydrolyze the insulator.

### CITATION LIST

### Patent Literature

Patent Literature 1: JP2011-174175A

Patent Literature 2: JPH10-025523A

### SUMMARY OF THE INVENTION

### Problems to Be Solved by the Invention

However, in the method described in Patent Literature 1, there is a problem in that the processing cost becomes high because, in order to carbonize the insulator, it is necessary to heat the insulator to a high temperature of 500° C. or more, so that an enormous amount of thermal energy is required. Further, it is probable that the purity of the copper that can be recovered decreases because, during heating, the conductor may be oxidized, or the carbonized material and the conductor may become integrated with each other.

In the method described in Patent Literature 2, there is a problem in that the environmental load becomes large and the processing cost becomes high because a highly concentrated alkaline solution is required, so that the cost of the chemical agent is incurred, and wastewater treatment is required. Further, the processing cost becomes even higher because heating is required in order to hydrolyze the insulator.

Further, when enameled wires having various shapes and lengths recovered from, for example, motors are mixed together, there has been a demand for a method capable of efficiently recovering copper in a batch manner.

Therefore, an object of the present invention is to provide a method for recovering copper or copper alloy from enameled wire, which has a low environmental load and low processing cost, and which is capable of efficiently recovering copper in a batch manner even when enameled wires having various shapes and lengths are mixed together.

### Means for Solving the Problems

To solve the above problem, the present invention provides a method for recovering copper or copper alloy from enameled wire, by removing an insulator from an enameled wire including the insulator around a conductor made of copper or copper alloy, comprising:
a crushing step of charging a plurality of enameled wires having different lengths and shapes into a crusher and crushing the enameled wires to shorten the enameled wires;
a separating step of subjecting the enameled wires shortened in the crushing step to compression processing or rolling processing to separate the insulator from the conductor; and
a stripping step of stripping the insulator separated from the conductor in the separating step.

### Advantageous Effects of the Invention

According to the present invention, it is possible to provide a method for recovering copper or copper alloy from enameled wire, which has a low environmental load and low processing cost, and which is capable of efficiently recovering copper in a batch manner even when enameled wires having various shapes and lengths are mixed together.

### BRIEF DESCRIPTION OF DRAWINGS

FIG. 1 is a schematic drawing showing an apparatus for recovering copper or copper alloy from enameled wire, which is used for a method for recovering copper or copper alloy from enameled wire, according to an embodiment of the present invention.

FIG. 2 is an explanatory diagram for explaining a separating step.

FIGS. 3A and 3B are diagrams showing a modified example of a separating device.

FIGS. 4A and 4B are diagrams showing an example of rolling rolls subjected to knurling processing.

FIG. 5 is a diagram showing a modified example of a stripping device.

FIG. 6 is a flow chart showing the method for recovering copper or copper alloy from enameled wire according to the embodiment of the present invention.

### DETAILED DESCRIPTION OF THE INVENTION

### Embodiment

The embodiments of the present invention will be described in conjunction with the accompanying drawings.

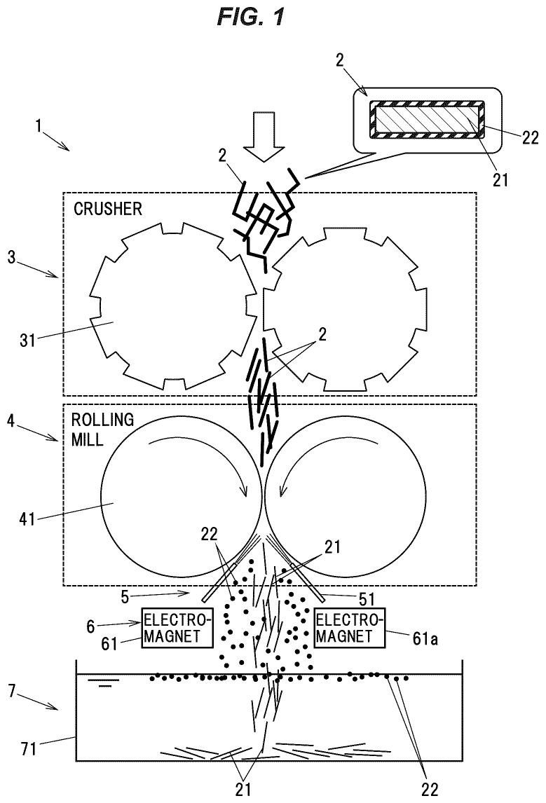

FIG. 1 is a schematic drawing showing an apparatus 1 for recovering copper or copper alloy from enameled wire (hereinafter, simply referred to as the recovery apparatus 1) used for a method for recovering copper or copper alloy from enameled wire, according to an embodiment of the present invention. As shown in FIG. 1, the recovery apparatus 1 is an apparatus for recovering copper or copper alloy constituting a conductor 21 by removing an insulator 22 from the conductor 21 of an enameled wire 2.

The enameled wire 2 is an electric wire used for, e.g., a motor for vehicles, a transformer, or an induction heating coil. The enameled wire 2 may be a round wire with a circular cross-section, or a flat wire with a rectangular cross-section. In addition, the enameled wire 2 is not limited to the round wire and the flat wire. For example, the cross-section may be elliptical or triangular, and the cross-section is not limited thereto. The enameled wire 2 includes the conductor 21 made of copper or copper alloy, and the insulator 22 formed by coating and heating enamel varnish around the conductor 21. The insulator 22 is made of, e.g., polyimide, polyamide-imide, polyester, polyurethane, or polyimide ester.

It is known that the insulator 22 has high adhesion to the conductor 21 in the enameled wire 2. Thus, it is not easy to remove the insulator 22 from the conductor 21 and recover the conductor (i.e., recovering copper or copper alloy constituting the conductor 21) when disposing the enameled wire 2. The recovery apparatus 1 according to the embodiment can easily remove the insulator 22 from the enameled wire 2 having high adhesion between the conductor 21 and the insulator 22, and achieve easy recovery of copper or copper alloy constituting the conductor 21. Further, in the recovering apparatus 1 according to the present embodiment, it is possible to collectively process enameled wires 2 having various shapes and lengths recovered from, for example, motors, that is, loose enameled wires 2, and to recover copper.

As shown in FIG. 1, the recovering apparatus 1 includes a crusher 3, a separating device 4, a stripping device 5, an iron removing device 6, and a sorting device 7.

### (Crusher 3)

The crusher 3 is a device for performing a crushing step of crushing the enameled wire 2 to shorten the enameled wire 2. The crusher 3 collectively crushes loose enameled wires 2 (enameled wires 2 having various shapes and lengths) and shortens (shreds) the enameled wires 2. Into the crusher 3, for example, a lump formed by bundling loose enameled wires 2 is charged as a raw material. As the crusher 3, for example, a so-called roll crusher having a pair of crushing rolls 31 can be used. The crusher 3 is preferably adjusted in such a manner that the length of the enameled wire 2 after the crushing step becomes 150 mm or less, and more preferably becomes a length of about 100 mm.

### (Separating Device 4)

The separating device 4 is a device for performing a separating step of subjecting the enameled wire 2 to compression processing (press processing) or rolling processing to separate the insulator 22 from the conductor 21.

In the example shown in FIG. 1, the separating device 4 includes a pair of rolling rolls 41, and is configured such that the enameled wire 2 sent from the crusher 3 above (falling from the crusher 3) is rolled by the pair of rolling rolls 41 under a constant load.

Here, although a case in which the separating device 4 is constituted by one pair of rolling rolls 41 is shown, the separating device 4 may be constituted by providing a plurality of pairs of rolling rolls 41 in multiple stages. According to this configuration, partially separated portions between the conductor 21 and the insulator 22 are more likely to be generated.

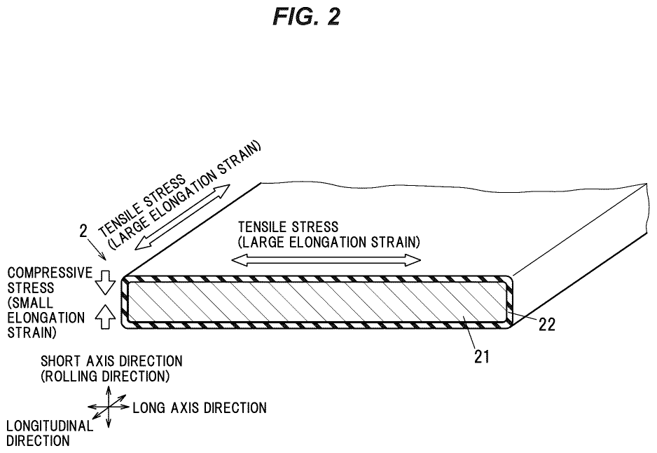

By subjecting the enameled wire 2 to rolling processing, as shown in FIG. 2, the enameled wire 2 is deformed so as to be spread in a direction perpendicular to a rolling direction (a short-axis direction of the enameled wire 2 in the illustrated example), compressive stress acts in the rolling direction, and tensile stress acts in a direction perpendicular to the rolling direction (a long-axis direction and a longitudinal direction of the enameled wire 2 in the illustrated example). Then, in the long-axis direction and the longitudinal direction of the enameled wire 2, the enameled wire 2 is elongated, and due to a difference in stretchability between the conductor 21 and the insulator 22, shear stress is generated at an interface between the conductor 21 and the insulator 22, thereby causing partial separation between the conductor 21 and the insulator 22.

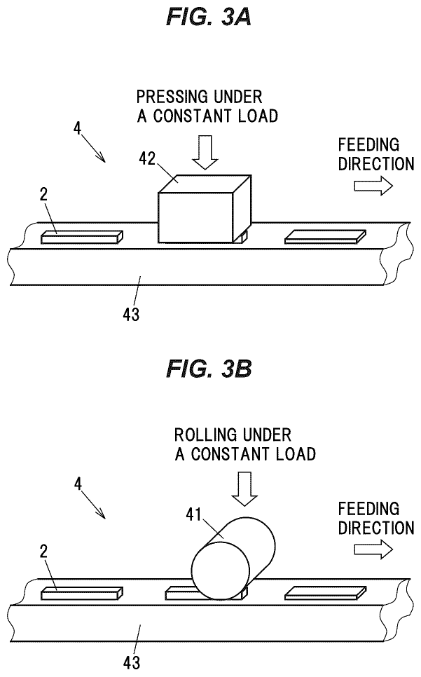

Here, although a case in which rolling processing is performed in the separating device 4 has been described, as shown in FIG. 3A, the separating device 4 may be configured to perform compression processing (press processing) on the enameled wire 2 by a press machine 42. In this case, the enameled wire 2 shortened after the crushing step may be conveyed by a conveying device 43, and press processing may be performed by the press machine 42. Similarly, as shown in FIG. 3B, the separating device 4 may be configured such that rolling processing is performed by the rolling rolls 41 while conveying the enameled wire 2 by the conveying device 43. In this case, by configuring such that the rolling rolls 41 are pressed under a constant load, it becomes possible to cope with enameled wires 2 having various sizes.

Further, in the case where rolling processing is performed in the separating step, it is preferable that the rolling processing is performed to have “A” expressed in the following formula be 15.1% or more:
A={(A1−A2)/A2}×100,
where A1 is a cross-sectional area of the conductor 21 before the rolling processing and A2 is a cross-sectional area of the conductor 21 after the rolling processing. Herein, “A” correlates with an elongation during rolling. Accordingly, the insulator 22 can be more easily separated from the conductor 21.

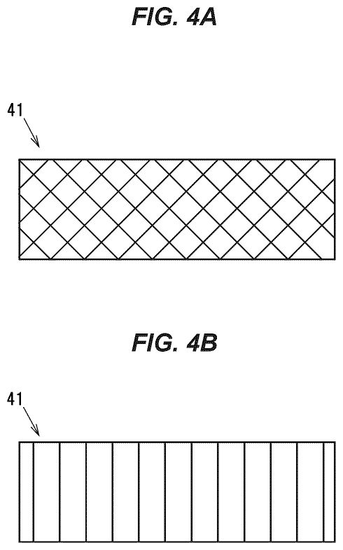

Further, the rolling rolls 41 or the press machine 42 may be subjected to knurling processing so as to shear the insulator 22 during the separating step and facilitate separation from the conductor 21. For example, as shown in FIG. 4A, diagonal knurling processing may be applied to the rolling rolls 41, or as shown in FIG. 4B, straight knurling processing may be applied to the rolling rolls 41. FIGS. 4A and 4B are plan views showing the rolling rolls 41 viewed from a radial direction.

Further, in the separating step, both compression processing and rolling processing may be performed. Accordingly, the insulator 22 becomes more easily separated from the conductor 21. Here, the “separation” means bringing the insulator 22 into a state in which the insulator 22 is partially or entirely separated from the conductor 21.

### (Stripping Device 5)

The stripping device 5 is a device for performing a stripping step of stripping the insulator 22, which is separated from the conductor 21 in the separating step. In the stripping device 5, by applying impact to the enameled wire 2 that has undergone the separating step, the insulator 22 is stripped from the conductor 21. In the example shown in FIG. 1, the stripping device 5 is constituted by a water jet (high-pressure water injection device) that injects a water flow from a nozzle 51 toward the enameled wire 2, thereby applying impact to the enameled wire 2. It is preferable that the water pressure of the water jet is 1 MPa or more and 30 MPa or less.

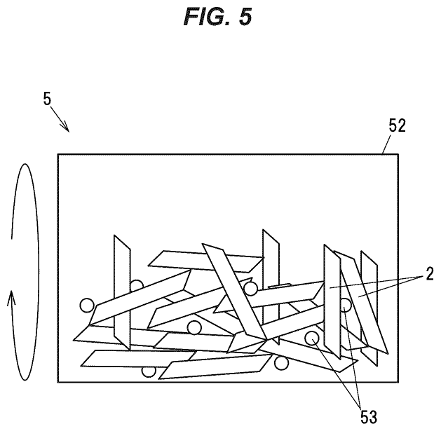

However, the stripping device 5 is not limited to the water jet, and may be, for example, a blast device that performs blast processing, or a barrel polishing device that performs barrel polishing. Further, as shown in FIG. 5, a ball mill device may be used, in which the enameled wire 2 and hard balls 53 made of ceramic or the like are accommodated in a barrel 52, and by rotating the barrel 52, impact is applied to the enameled wire 2 by the balls 53 to strip the insulator 22 from the conductor 21. Here, the “stripping” means separating the conductor 21 and the insulator 22 from each other, i.e., into individual components.

### (Iron Removing Device 6)

The iron removing device 6 is a device for performing an iron removing step of removing iron using a magnet 61 after the stripping step. In the enameled wire 2 taken out from, for example, motors, iron may be contained. If iron is contained in the recovered copper, depending on the use, problems may occur. For example, when the recovered copper is reused as a raw material of the enameled wire 2, if iron is contained in the recovered copper, there is a high possibility that problems occur. This is because, in mass production of enameled wire 2, a continuous casting and rolling apparatus is generally used, and mixing of iron into the continuous casting and rolling apparatus greatly affects quality of products. Note that enameled wire is generally manufactured by producing a rough-drawn wire from a copper raw material using a continuous casting and rolling apparatus, then producing a conductor by drawing the rough-drawn wire using a wire drawing apparatus, and coating and drying an enamel varnish around the conductor using a coating apparatus to form an insulator.

Therefore, in the present embodiment, iron is removed by the iron removing device 6. In the example shown in FIG. 1, an electromagnet 61a is used as the magnet 61. Since the electromagnet 61a can easily release attracted iron, it is suitable for the iron removing device 6. However, the magnet 61 is not limited thereto, and a permanent magnet may of course be used. Further, for example, the magnet 61 may be mounted in the ball mill device shown in FIG. 5, so that the stripping step and the iron removing step can be performed simultaneously.

### (Sorting Device 7)

The sorting device 7 is a device for performing a sorting step of sorting the conductor 21 and the insulator 22 by a difference in specific gravity after the stripping step. The sorting device 7 includes a water tank 71 that stores a sorting liquid, in which the conductor 21 sinks and the insulator 22 floats. As the sorting liquid stored in the water tank 71, for example, water can be used. Further, an aqueous solution in which sodium chloride is dissolved may be used, or tetrabromoethane having a large specific gravity (specific gravity 2.96) may be used, and the specific gravity of the sorting liquid may be appropriately adjusted to efficiently perform the sorting step. By removing the insulator 22 floating in the water tank 71 and recovering the conductor 21 that has sunk, copper or copper alloy constituting the conductor 21 can be recovered. Further, by appropriately adjusting the specific gravity of the sorting liquid, even for the insulator 22 having a relatively large specific gravity, such as polyamide-imide, sorting can be performed by utilizing a difference in sedimentation speed. Further, although a method of sorting using the water tank 71 has been described here, the method is not limited thereto. For example, by blowing air using a blower to blow away the insulator 22 that is lighter than copper and collecting the insulator 22 with a dust collector, copper or copper alloy constituting the conductor 21 can also be recovered.

(Method for Recovering Copper or Copper Alloy from Enameled Wire)

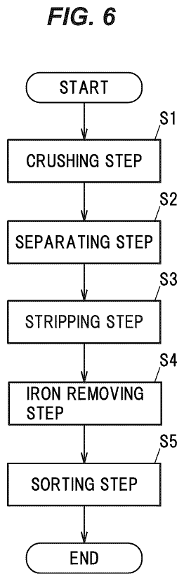

FIG. 6 is a flow chart showing the method for recovering copper or copper alloy from enameled wire according to the present embodiment. As shown in FIG. 6, in the method for recovering copper or copper alloy from enameled wire according to the present embodiment, first, a crushing step is performed in Step S1. In the crushing step, a plurality of enameled wires 2 having different lengths and shapes are charged into the crusher 3, and the enameled wires 2 are crushed to shorten the enameled wires 2.

Thereafter, a separating step is performed in Step S2. In the separating step, by the separating device 4, compression processing or rolling processing is applied to the enameled wires 2 shortened in the crushing step, and the insulator 22 is separated from the conductor 21. At this time, compression processing or rolling processing is performed in such a manner that a value A having a correlation with elongation during rolling becomes 15.1% or more.

Thereafter, a stripping step is performed in Step S3. In the stripping step, by applying impact to the enameled wires 2 using the stripping device 5 such as a water jet, the insulator 22 separated in the separating step is stripped from the conductor 21.

Thereafter, an iron removing step is performed in Step S4. In the iron removing step, iron is removed by the iron removing device 6 using the magnet 61 (electromagnet 61a).

Thereafter, a sorting step is performed in Step S5. In the sorting step, the separated conductor 21 and insulator 22 are charged into the water tank 71 storing the sorting liquid, and the conductor 21 and the insulator 22 are sorted by a difference in specific gravity (depending on whether they float or sink). Then, the insulator 22 floating in the sorting liquid is removed, and the conductor 21 that has sunk is collected.

### (Functions and Effects of the Embodiment)

As described above, in the method for recovering copper or copper alloy from enameled wire according to the present embodiment, the method includes a crushing step of charging a plurality of enameled wires 2 having different lengths and shapes into the crusher 3 and crushing the enameled wires 2 to shorten the enameled wires 2, a separating step of applying compression processing or rolling processing to the enameled wires 2 shortened in the crushing step to separate the insulator 22 from the conductor 21, and a stripping step of stripping the insulator 22 separated in the separating step from the conductor 21.

With such a configuration, even when enameled wires 2 having various shapes and lengths are mixed together, copper can be efficiently recovered in a batch manner. In the present embodiment, since chemicals requiring wastewater treatment are not used, environmental load is small. Further, since heat treatment is not required, the conductor 21 is not oxidized and the carbonized insulator 22 is not integrated with the conductor 21, and thus high-purity copper can be recovered. Further, in the present embodiment, it is not necessary to perform treatment using chemicals having high processing cost, and since general equipment for compression processing or rolling processing can be diverted, equipment cost and processing cost are extremely low, and copper or copper alloy can be recovered at low cost.

### (Summary of the Embodiment)

Next, technical ideas grasped from the embodiment described above will be described below with reference to reference numerals and the like used in the embodiment. However, each reference numeral described below is not intended to limit constituent elements in the claims to members or the like specifically described in the embodiment.

[1] A method for recovering copper or copper alloy from enameled wire, by removing an insulator (22) from an enameled wire (2) including the insulator (22) around a conductor (21) made of copper or copper alloy, comprising:
a crushing step of charging a plurality of enameled wires (2) having different lengths and shapes into a crusher (3) and crushing the enameled wires (2) to shorten the enameled wires (2);
a separating step of subjecting the enameled wires (2) shortened in the crushing step to compression processing or rolling processing to separate the insulator (22) from the conductor (21); and
a stripping step of stripping the insulator (22) separated from the conductor (21) in the separating step.

[2] The method for recovering copper or copper alloy from enameled wire, according to claim 1, further comprising:
an iron removing step of removing iron using a magnet (61) after the stripping step.

[3] The method for recovering copper or copper alloy from enameled wire, according to claim 1, further comprising:
a sorting step of sorting the conductor (21) and the insulator (22) by a difference in specific gravity after the stripping step.

[4] The method for recovering copper or copper alloy from enameled wire, according to claim 1, wherein, in the separating step, the rolling processing is performed to have A expressed in a following formula be 15.1% or more:
A={(A1−A2)/A2}×100,
where A1 is a cross-sectional area of the conductor (21) before the rolling processing and A2 is a cross-sectional area of the conductor (21) after the rolling processing.

### (Note)

Although the embodiment of the invention has been described, the invention according to claims is not to be limited to the above-described embodiment. Further, please note that not all combinations of the features described in the embodiment are necessary to solve the problem of the invention. In addition, the various kinds of modifications can be implemented without departing from the gist of the invention.

### EXPLANATION OF SIGNS

1 . . . Apparatus for recovering copper or copper alloy
2 . . . Enameled wire
21 . . . Conductor
22 . . . Insulator
3 . . . Crusher
4 . . . Separating device
5 . . . Stripping device
6 . . . Iron removing device
7 . . . Sorting device

1. A method for recovering copper or copper alloy from enameled wire, by removing an insulator from an enameled wire including the insulator around a conductor made of copper or copper alloy, comprising:
a crushing step of charging a plurality of enameled wires having different lengths and shapes into a crusher and crushing the enameled wires to shorten the enameled wires;
a separating step of subjecting the enameled wires shortened in the crushing step to compression processing or rolling processing to separate the insulator from the conductor; and
a stripping step of stripping the insulator separated from the conductor in the separating step.

2. The method for recovering copper or copper alloy from enameled wire, according to claim 1, further comprising:
an iron removing step of removing iron using a magnet after the stripping step.

3. The method for recovering copper or copper alloy from enameled wire, according to claim 1, further comprising:
a sorting step of sorting the conductor and the insulator by a difference in specific gravity after the stripping step.

4. The method for recovering copper or copper alloy from enameled wire, according to claim 1, wherein, in the separating step, the rolling processing is performed to have A expressed in a following formula be 15.1% or more:
A={(A1−A2)/A2}×100,
where A1 is a cross-sectional area of the conductor before the rolling processing and A2 is a cross-sectional area of the conductor after the rolling processing.
